(19) United States
(12) Patent Application Publication
(10) Pub. No.: US 2022/0198442 A1
(43) Pub. Date: Jun. 23, 2022

(54) SECURE COMMUNICATIONS FOR MOBILE WALLET APPLICATIONS

(71) Applicant: Wells Fargo Bank, N.A., San Francisco, CA (US)

(72) Inventors: Joon Maeng, Newcastle, WA (US); Thomas Hayes, Katy, TX (US); Ramanathan Ramanathan, Bellevue, WA (US)

(21) Appl. No.: 15/373,414

(22) Filed: Dec. 8, 2016

(51) Int. Cl. G06Q 20/36; G06Q 20/38

(52) U.S. Cl. CPC G06Q 20/3674; G06Q 2220/00; G06Q 20/3829

(57) ABSTRACT

Various examples are directed to secure communications for mobile wallet applications. A first mobile wallet application may send a content request describing a first offering to a wallet management system. The first mobile wallet application may receive from the wallet management system first merchant web content describing the first offering. The first merchant web content may be verified by the wallet management system and may comprise first address data describing a first address of a first merchant payment gateway. The first mobile wallet application may send payment data to the first merchant payment gateway at the first address. The payment data may indicate a payment amount for the first offering.

### TECHNICAL FIELD

Embodiments described herein generally relate to systems and methods for secure communications between one or more mobile wallet applications executing at user computing devices and, optionally, between one or more mobile wallet applications and a wallet management system.

### BACKGROUND

Mobile wallet applications can allow consumers to make payments for products and services using user computing devices instead of cash, credit cards, check card, or checks.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram showing one example of an environment for secure communications for mobile wallet applications.

FIG. 2 is a transaction diagram showing one example of transactions for implementing secure caching of merchant web content.

FIG. 3 is a diagram showing another example of the environment configured to facilitate value token exchange between mobile wallet applications.

FIG. 4 is a flowchart showing one example of a process flow that may be executed by the mobile wallet application and wallet management system of FIG. 3 to acquire a value token and add the value token to the value token pool.

FIG. 5 is a transaction diagram showing one example of transactions for exchanging a value token between a first mobile wallet application and a second mobile wallet application.

FIG. 6 is a diagram showing one example configuration of the user interface provided to a user of the mobile wallet application showing value tokens from the value token pool that are relevant to a selected offering.

FIG. 7 is a diagram showing one example of the environment configured to implement a group purchase incentive.

FIG. 8 is a diagram showing one example configuration of the user interface provided to a user of the mobile wallet application showing a group purchase incentive field.

FIG. 9 is a flowchart showing one example of a process flow that may be executed by the wallet management system to facilitate a group purchase incentive.

FIG. 10 is a diagram showing one example of an environment for secure digital communication between mobile wallet applications.

FIG. 11 is a diagram showing one example of a mobile wallet to mobile wallet secure digital communication.

FIG. 12 is a block diagram showing an example architecture of a user computing device.

FIG. 13 is a block diagram showing one example of a software architecture for a computing device.

FIG. 14 is a block diagram illustrating a computing device hardware architecture, within which a set or sequence of instructions can be executed to cause the machine to perform examples of any one of the methodologies discussed herein.

### DETAILED DESCRIPTION

A user may utilize a mobile wallet application to make a payment to a payee. The payee may be a merchant making an offering of goods or services for sale or any other suitable party including, for example, another mobile wallet application user.

A user may utilize a user computing device, or other user computing device, to view merchant web pages or other merchant web content. Merchant web content may include information describing offers of products and/or services made by the merchant. For example, an online retailer may provide a web page describing one or more products (and/or services) offered for sale. The user may browse the web content and select an offered product (and/or service) to purchase. The web content may also include a link to a payment gateway. To complete a purchase, the user may provide payment data to the payment gateway indicated by the link. Payment data may describe a credit card, check card, mobile wallet application, etc. used to provide payment.

Merchant web pages and other web content can present certain security risks. For example, some merchant web content is vulnerable to a man-in-the-middle attack. According to a man-in-the-middle attack, a third party poses as the payment gateway. For example, the third party embeds a false link in the merchant web content. Instead of pointing to the merchant's payment gateway, the false link points to a third party system. The user, then, provides payment data to the third party system instead of to the merchant's payment gateway. The third party uses the payment data to make unauthorized charges to the user's credit card, check card, etc.

Some examples described herein are directed to a secure mobile wallet application and/or secure wallet management system that minimize the risk of man-in-the-middle and other security risks associated with online purchases by utilizing secure caching at the wallet management system. For example, the wallet management system may communicate with one or more merchant web servers and request merchant web content. The merchant web service may digitally sign the merchant web content to generate signed merchant web content. The merchant web server may provide the signed merchant web content to the wallet management system.

A mobile wallet application user may access the signed merchant web content through the mobile wallet application. For example, the mobile wallet application may query the wallet management system. The wallet management system may respond to the query by providing the mobile wallet application with web content that includes some or all of the signed merchant web content. The mobile wallet application may display the signed merchant web content, for example, via a WebView or other software tool embedded into the mobile wallet application. The user may browse the signed web content and select a product and/or service offering for purchase. The user may complete the purchase, for example, by accessing a link to the merchant's payment gateway included with the signed merchant web content. Because the link is part of the web content data digitally signed by the merchant web server, it is more difficult for a third party to substitute the link for a false link to the third party system.

In other examples, it may be desirable for two or more mobile wallet applications to securely communicate directly with one another. For example, a wallet management system may manage a domain including one or more mobile wallet applications. Some examples may also include additional domains in which additional wallet management systems manage additional mobile wallet applications. The wallet management system may include a public key server and a message transfer agent. A sender mobile wallet application may send to the message transfer agent a message including address data describing a recipient mobile wallet application. If the recipient mobile wallet application is part of the domain managed by the wallet management system, the message transfer agent may retrieve a public key for the recipient mobile wallet application from the public key server, encrypt the message with the public key, and provide the encrypted message to the recipient mobile wallet application. If the recipient mobile wallet application is part of a second domain, the message transfer agent may query a second public key server of a second wallet management system at the second domain to retrieve the public key for the recipient. The message transfer agent may send the public key back to the mobile wallet application to encrypt the message and/or may encrypt the message with the public key and send the encrypted message to a second message transfer agent of the second wallet management system. The second message transfer agent may direct the message to the recipient mobile wallet application.

In some examples, secure communications for mobile wallet applications, as described herein, may be utilized to provide mobile wallet users with additional features. In some examples, secure communications for mobile wallet applications may facilitate the collection and exchange of value tokens between mobile wallet applications. A value token may be any item that can be redeemed digitally or in-person to reduce the price of a merchant offering. Examples of value tokens include coupons, rebates, gift cards, other pre-paid merchant credit, etc.

Value tokens that can be redeemed digitally may include value token data. For example, a merchant or other party may redeem a value token upon receiving the value token data. Value tokens may also comprise value token descriptive data. Value token descriptive data may describe the value token but may not itself be redeemable. Value tokens often have subject matter limitations. For example, some coupons are redeemable only to reduce the price of a particular product or service. Some gift cards, coupons, etc., are redeemable only by a particular merchant. Accordingly, value tokens can be useful to a user, but only if the user possesses a value token that can be redeemed for the offering that the user wishes to purchase.

In some examples, owners of value tokens may be willing to transfer their value tokens to others at a discount from the face value. For example, a wallet management system maintains a value token pool describing value tokens held by multiple different mobile wallet applications in communication with the wallet management system. For example, when a user obtains a value token (e.g., a value token that the user does not anticipate using) the user may provide value token data and/or value token descriptive data to the wallet management system. When a mobile wallet application requests merchant web content describing a merchant offering (e.g., a product and/or service for sale), the wallet management system may identify value tokens from the value token pool that are redeemable to reduce the price of the offering. The wallet management system may provide indications of the identified value tokens to the requesting mobile wallet application, along with an indication of the mobile wallet applications that hold the value tokens (e.g., the holding mobile wallet application(s)). The requesting mobile wallet application may select one or more value tokens and negotiate a transfer price with the holding mobile wallet application. In some examples, the wallet management system may hold the transfer price in escrow until it receives an indication that the holding mobile wallet application has transferred the value token to the requesting mobile wallet application.

Also, in some examples, secure communications for mobile wallet applications, as described herein, may be utilized to administer group incentives for offerings. For example, a merchant may offer a discount to the price of an offering based on the number of users who purchase the offering in a given time period. The wallet management system may provide requesting mobile wallet applications with data describing the number of purchases during the time period. The wallet management system may also, in some examples, maintain a portion of a mobile wallet application purchase price in escrow until the expiration of the time period. If the number of purchasers during the time period increases (and thereby causes the purchase price to fall), the wallet management system may release all or a portion of the escrowed purchase price back to the mobile wallet application (e.g., a payment element thereof). All or a portion of the escrowed purchase price that is not returned to the mobile wallet application may be forwarded to the merchant at the conclusion of the time period.

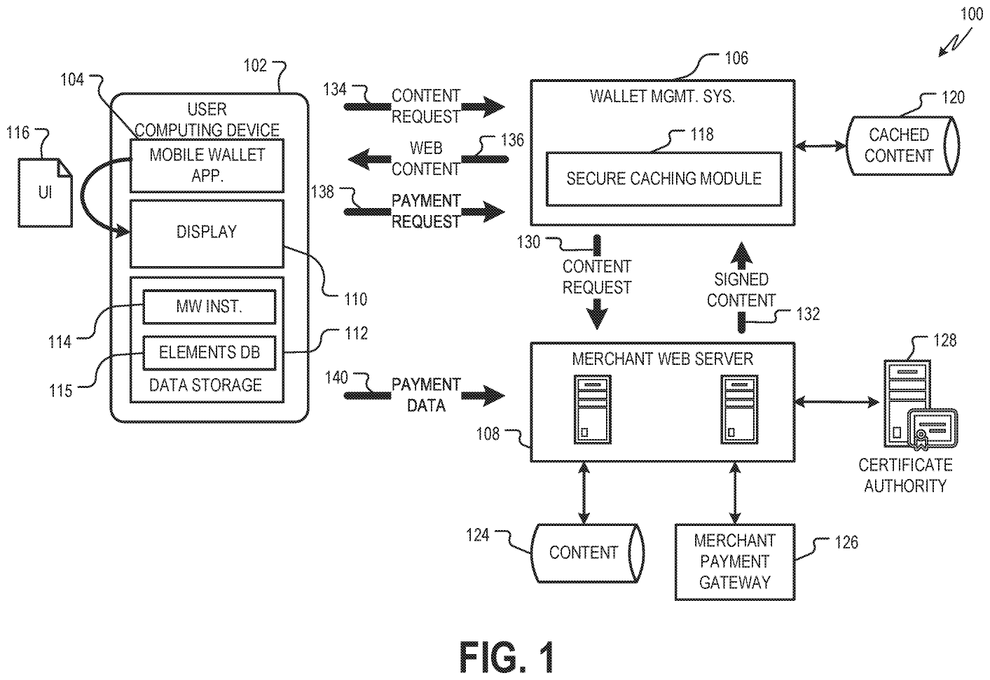

FIG. 1 is a diagram showing one example of an environment 100 for secure communications for mobile wallet applications. The environment 100 includes a user computing device 102, a wallet management system 106, and a merchant web server 108. The user computing device 102 may be any computing device suitable for executing a mobile wallet application 104. Example user computing devices 102 may include smart phones, tablet computers, laptop computers, smart watches, etc. The mobile wallet application 104 (sometimes referred to herein as a mobile wallet), may be executed by a processing unit of the user computing device 102.

The mobile wallet application 104 may be programmed to manage mobile wallet elements, including payment elements and non-payment elements. Payment elements may be and/or reference user accounts that can fund a payment including, for example, credit card accounts, debit accounts, checking accounts, etc. For example, a user may utilize the mobile wallet application 104 to make online and/or in-person payments from payment elements. Non-payment elements may be and/or reference, user accounts, memberships, etc. that do not include funds for making a payment. Examples of non-payment elements include employee cards, insurance cards, membership cards, and driver's licenses. For example, the user may utilize the mobile wallet application 104 to present non-payment elements, for example, as proof of identity, to receive a service, etc. Example mobile wallet applications include, but are not limited to, APPLE PAY®, ANDROID PAY®, GOOGLE WALLET®, CURRENT C® by MCX®, SAMSUNG PAY®, and peer-to-peer payment apps such as VENMO®, SQUARE CASH®, and TILT APP®.

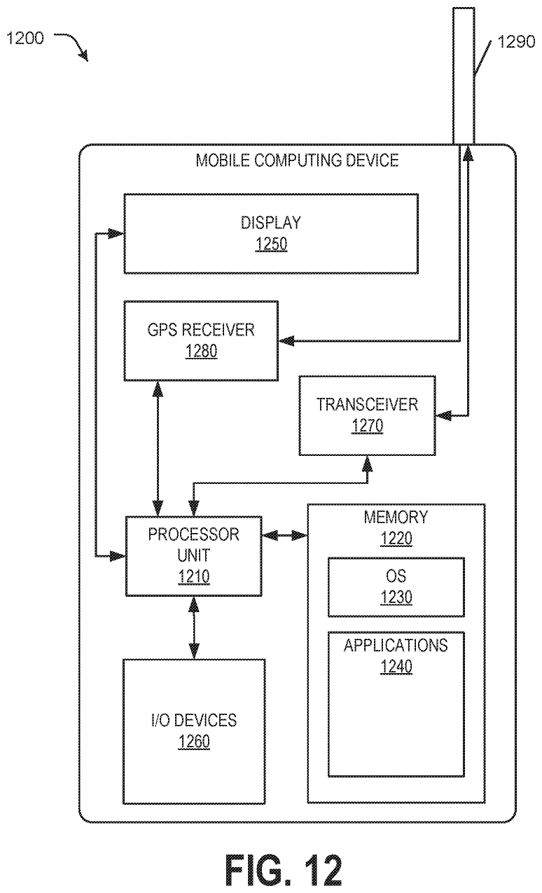

The user computing device 102 may comprise data storage 112, which may store data for executing the mobile wallet application 104 as described herein. For example, the data storage 112 may store mobile wallet instructions 114. A processing unit of the user computing device 102 may execute the mobile wallet instructions 114 to implement the mobile wallet application 104. (See FIGS. 12-14 for examples of processors and other processing units in computing devices.) The data storage 112 may also store other data for the mobile wallet application 104 including, for example, at an elements database 115. The elements database 115 may comprise data describing one or more payment or non-payment elements of the mobile wallet application 104. Data stored at the elements database 115 may include, for example, identification data uniquely identifying an element, historical usage data describing past uses of an element by the mobile wallet application 104, usage policy data describing when an element may be used, etc.

The user computing device 102 may also comprise a display 110. The display 110 may be or include any suitable type of display including, for example, a liquid crystal display (LCD), an organic light emitting diode (OLED) display etc. In some examples, the display 110 is a touchscreen or other touch-sensitive display allowing a user to providing input to the GUI 116. In some examples, the mobile wallet application 104 is programmed to generate a graphical user interface (GUI) 116. The GUI 116 may be generated by the mobile wallet application 104 and displayed at the display 110. The user may provide input via the GUI 116 using the touchscreen. Also, in some examples, a user may provide input to the GUI 116 using various other input devices of the user computing device 102 in addition to or instead of using a touchscreen. Other input devices may include, for example, a mouse, a track ball, etc.

The wallet management system 106 may manage the mobile wallet application 104 and, in some examples, is implemented by a provider of the mobile wallet (e.g., a mobile wallet provider). In some examples, the mobile wallet provider is a financial institution, software company, or any other organization that provides and maintains the mobile wallet application 104. For example, the GOOGLE WALLET® mobile wallet application may be provided and maintained by Google, Inc.

The wallet management system 106 may comprise one or more computing devices, such as servers, configured to operate as described herein. Computing devices making up the wallet management system 106 may be located at a single geographic location and/or may be distributed across multiple geographic locations. In some examples, the wallet management system 106 may be implemented in a “cloud computing” environment or as a “software as a service” (SaaS). For example, at least some of the operations of the wallet management system 106 may be performed by a group of computing devices, with these operations being accessible via a network and/or via one or more appropriate interfaces (e.g., an Application Program Interface (API)).

The merchant web server 108 may provide offers of products and/or services to users of the mobile wallet application 104. For example, the merchant web server 108 may provide merchant web content describing offers of goods and/or service made to users of the mobile wallet application 104. Merchant web content may be stored at a content data store 124 in communication with the merchant web server 108.

The merchant web server 108 may include and/or be in communication with a merchant payment gateway 126. The merchant payment gateway 126 may authorize payments made to the merchant (e.g., as purchase payments for an offering of a product or service made by the merchant). For example, the merchant payment gateway 126 may accept payment from a payment element of the mobile wallet. A merchant payment gateway 126 may be implemented by the merchant and/or provided by a bank or other service provider. In some examples, the merchant payment gateway 126 is described by address data, such as a Universal Resource Locator (URL). For example, a user making payment via the merchant payment gateway 126 may direct payment data to the URL or other address of the merchant payment gateway 126. When the mobile wallet application 104 is used to make a payment, the mobile wallet application 104 may send payment data including, for example, element data describing a payment element (e.g., with credentials), to the URL or other address of the merchant payment gateway 126. In some examples, the payment data may be sent over a secure connection, such as an encrypted connection.

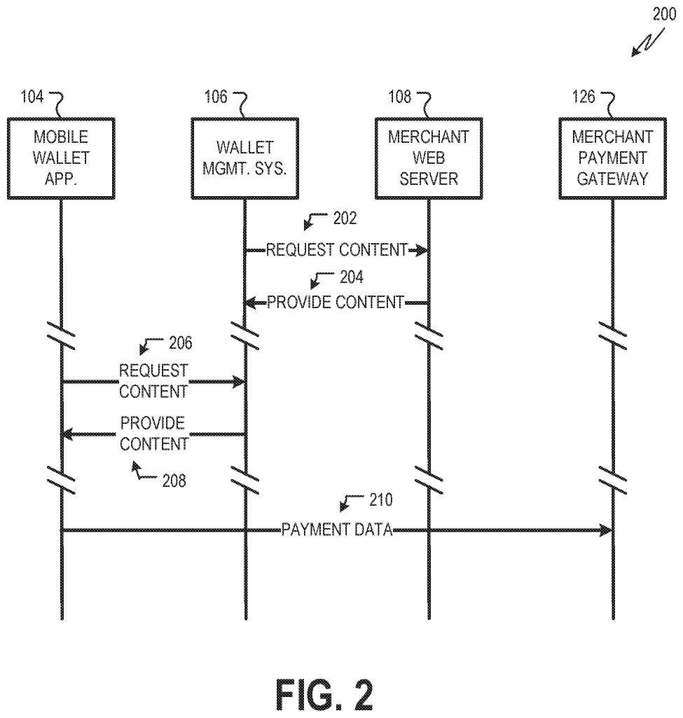

In the example configuration of the environment 100 shown in FIG. 1, the wallet management system 106 executes a secure caching module 118. The secure caching module 118 may cache digitally signed merchant web content 132, for example, at a cached content data store 120. FIG. 2 is a transaction diagram 200 showing one example of transactions for implementing secure caching of merchant web content. FIG. 2 is described herein in conjunction with FIG. 1.

At operation 202 (FIG. 2), the wallet management system 106 (e.g., the secure caching module 118 thereof), may send a content request 130 to the merchant web server 108. In response to the content request 130, the merchant web server 108, at operation 204 (FIG. 2) may provide digitally signed merchant web content 132 to the wallet management system 106 (e.g., the secure caching module 118).

Digitally signed merchant web content 132 may include digitally signed versions of web content that the merchant would otherwise provide directly to users browsing a website of the merchant. For example, the web content may describe one or more offerings of products and/or services made by the merchant. In an example where the merchant is an online retailer, the merchant web content may include content describing a product offered for sale. In an example where the merchant is an online publication (e.g., providing book, movie, music, or other content), merchant web content may include content describing a subscription to the publication.

The merchant web server 108 may generate digitally signed merchant web content 132 by digitally signing merchant web content 132 in any suitable manner. In some examples, the merchant web server 108 may sign web content utilizing a Public Key Infrastructure (PKI) or similar mechanism involving a public key and/or a private key. For example, the merchant web server 108 may have a public key and a private key. The merchant web server 108 may digitally sign merchant web content by performing a cryptographic operation on the merchant web content utilizing the merchant web server's public key. This may result in the digitally signed merchant web content 132. Depending on the technique used, any suitable cryptographic operation or combination of operations may be used to digitally sign the merchant web content including, for example, one or more encryption operations and/or one or more hashing operations. In some examples, the merchant web server 108 may encrypt merchant web content utilizing the merchant web server's private key. The digitally signed merchant web content 132, then, may include encrypted merchant web content.

The wallet management system 106 (e.g., secure caching module 118) may verify the digitally signed merchant web content 132, for example, by decrypting or performing another suitable cryptographic operation or operations on the digitally signed merchant web content 132 utilizing the public key of the merchant web server 108. For example, successfully decrypting or performing another suitable cryptographic operation on the digitally signed merchant web content 132 may verify that the content 132 was the same content that was digitally signed using the private key of the merchant web server 108.

Optionally, the merchant web server 108 may provide a digital certificate proving the authenticity of the merchant web server's public key. For example, the merchant web server 108 may provide a certificate authority 128 with proof of identity, including, for example, proof of the public and/or private key being used by the merchant web server 108. In return, the certificate authority 128 may provide a digital certificate that is, for example, digitally signed with a private key of the certificate authority 128. In this way, the digital certificate may verify the public key of the merchant web server 108 to the wallet management system 106. The digital certificate may be provided to the wallet management system 106 at the same time as the digitally signed merchant web content 132 and/or at a different time (e.g., prior to operations 202, 204). FIGS. 1 and 2 illustrate an interaction between the wallet management system 106 (e.g., secure caching module 118) and a single merchant web server 108. In some examples, however, the wallet management system 106 (e.g., secure caching module 118) may solicit and receive digitally signed merchant web content from multiple merchants.

The mobile wallet application 104, at operation 206 (FIG. 2), may send a content request 134 to the wallet management system 106 (e.g., the secure caching module). The content request 134 may identify a merchant (e.g., online retailer, etc.). In some examples, prior to operation 206, the wallet management system 106 may provide the mobile wallet application 104 with a listing of merchants for whom the wallet management system 106 has cached merchant web content. The mobile wallet application 104 may provide a list of the indicated merchants to a user, for example, via the UI 116.

At operation 208 (FIG. 2), the wallet management system (e.g., the secure caching module 118) may send to the mobile wallet application 104 merchant web content 136. The mobile wallet application 104 may display the received merchant web content 136, for example via the user interface 116. In some examples, the mobile wallet application 104 may display the merchant web content 136 utilizing a separate browser application. In some examples, in lieu of sending cached merchant web content 136, the wallet management system 106 may direct the mobile wallet application 104 to contact the merchant web server 108 directly. For example, the wallet management system 106 may direct to the mobile wallet application 104 to one or more pages or other web content that is cached at the wallet management system 106.

Also, in some examples, the mobile wallet application 104 may include a WebView or other similar software construct for displaying web content, such as the merchant web content 136, through the mobile wallet application 104 itself. In some examples where the mobile wallet application 104 is configured to run on an iOS operating system available from APPLE, INC., the WebView may be or include a UIWebView construct. In some examples where the mobile wallet application 104 is configured to run on an Android operating system available from GOOGLE, INC., the WebView may be or include a WebView construct.

The merchant web content 136 provided to the mobile wallet application 104 may be the same digitally signed merchant web content 132 received from the merchant web server 108. In some examples, the wallet management system 106, after having verified the digital signature of the digitally signed merchant web content 132, may provide unsigned merchant web content at operation 208.

A user of the mobile wallet application 104 may browse the merchant web content 136, for example, just as the user would browse the website or other web content provided directly by the merchant web server 108 (e.g., to a browser application). If the user chooses to accept an offering, the user may initiate a purchase. For example the user may prompt the mobile wallet application 104 to initiate payment for the offer, for example, by sending payment data 140 to the merchant payment gateway 126 at operation 210 (FIG. 2). Payment data 140 may indicate an amount of the payment (e.g., a payment amount). The mobile wallet application 104 may utilize the URL or other address of the merchant payment gateway 126 included with the merchant web content 136. Because the merchant web content 136 either is or is derived from the digitally signed merchant web content 132, the likelihood of the address of the merchant payment gateway 126 being maliciously replaced may be reduced. In some examples, in addition to or in lieu of sending the payment data 140 to the merchant payment gateway 126, the mobile wallet application 104 may send a payment request 138 to the wallet management system 106. The payment request 138 may request that the wallet management system 106 provide payment for the offering to the payment gateway 126.

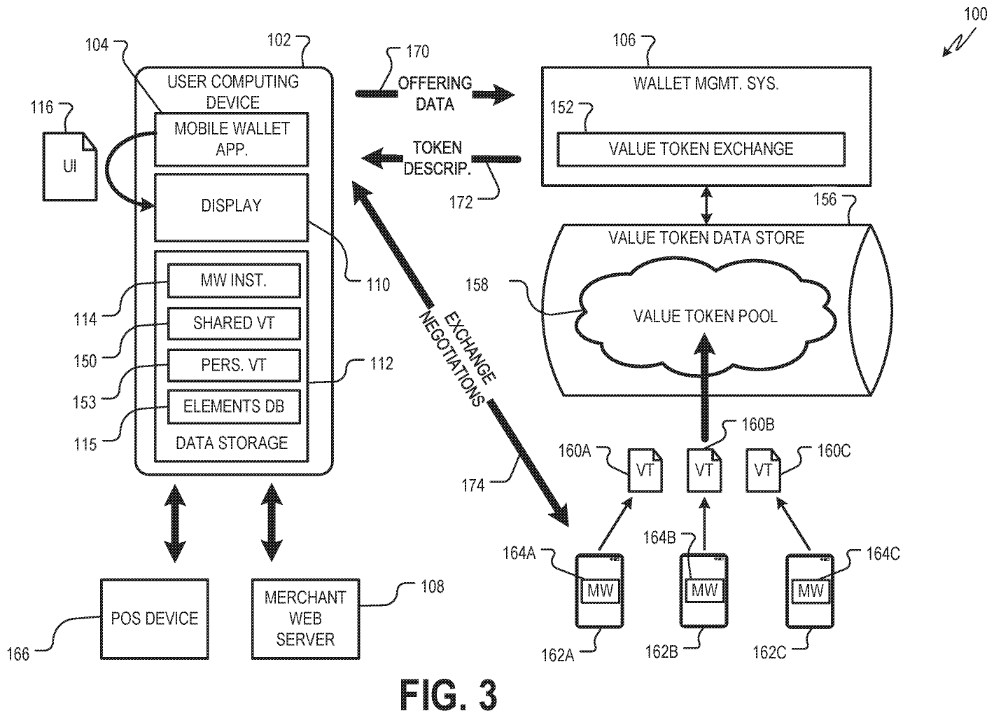

FIG. 3 is a diagram showing another example of the environment 100 configured to facilitate value token exchange between mobile wallet applications. In the example of FIG. 3, the wallet management system 106 executes a value token exchange module 152. The value token exchange module 152 may be used to facilitate the collection of value tokens 160A, 160B, 160C by mobile wallet applications 104, 164A, 164B, 164C. (In the example of FIG. 3, additional mobile wallet applications 164A, 164B, 164C are shown executing at user computing devices 162A, 162B, 162C).

Some or all of the value tokens 160A, 160B, 160C may be digitally redeemable and may include redeemable value token data. For example, a mobile wallet application 104, 164A, 164B, 164C may redeem a digitally-redeemable value token by providing value token data to a merchant, for example, in conjunction with a purchase of a merchant offering (e.g., a product or service offered for sale by the merchant). In some examples, a value token 160A, 160B, 160C may be physically-redeemable and may include a physical thing, such as a card, a paper, etc. that may be physically presented to a merchant (e.g., a clerk, a Point of Service (POS) device 166), etc. In some examples a value token 160A, 160B, 160C may include a serial number or other identifier. For example, the serial number may be provided to the merchant upon redemption, either as part of value token data or via the physical thing. The merchant may use the serial number to verify the value token.

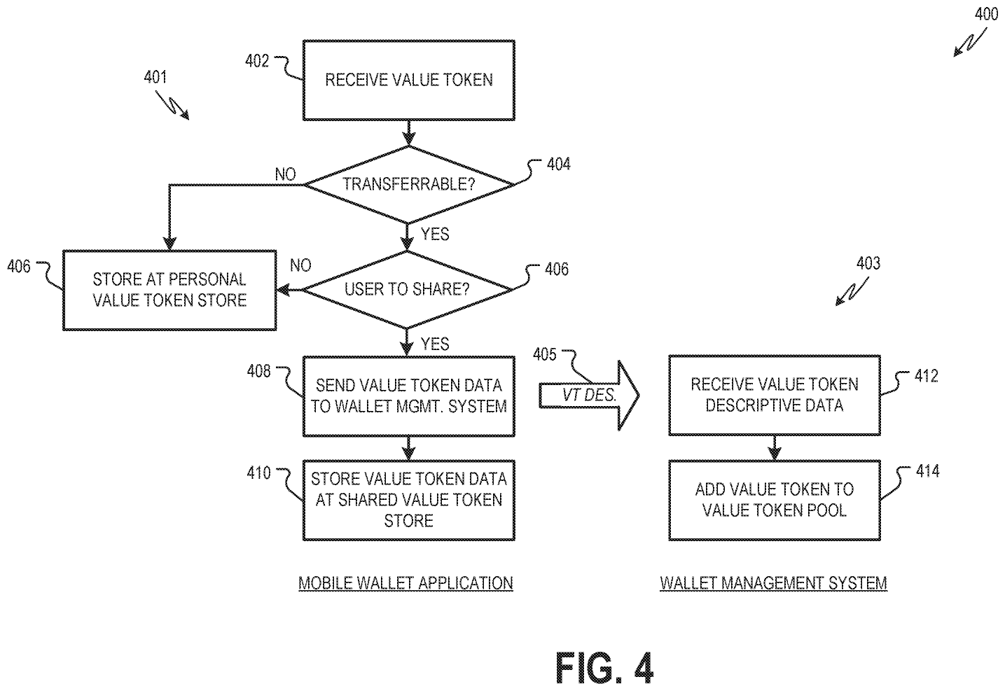

The wallet management system 106 may execute a value token exchange module 152 to receive and manage shared value tokens 160A, 160B, 160C. Users of mobile wallet applications 104, 164A, 164B, 164C may collect value tokens 160A, 160B, 160C and submit value token data and/or value token descriptive data for value tokens 160A, 160B, 160C, to the value token exchange module 152. Examples of how the various mobile wallet applications 104, 164A, 164B, 164C may collect and submit value tokens to the value token pool 158 are described herein, for example, with respect to FIG. 4.

The value token exchange module 152 may maintain a value token pool 158 stored at a value token data store 156 in communication with the wallet management system 106. The value token pool 158 may include value token data and/or token descriptive data describing value tokens 160A, 160B, 160C contributed by the various mobile wallet applications 104, 164A, 164B, 164C.

Referring now to the user computing device 102, the mobile wallet application 104 may maintain at the data storage 112 value token data and/or descriptive data for various value tokens held by the mobile wallet application 104. Data describing value tokens shared as part of the value token pool 158 (e.g., value token data and/or value token descriptive data) may be stored at a shared value token data store 150. In some examples, the mobile wallet application 104 may hold one or more value tokens that are not to be shared. For example, non-shared value tokens may be value tokens that are not transferrable to another user, value tokens that the user decides not to share, etc. In some examples, the mobile wallet application 104 may maintain at the data storage 112 a personal value token location 153 including value token data and/or descriptive data for value tokens that are held by the mobile wallet application 104 but not shared at the value token pool.

The mobile wallet application 104 may provide offering selection data 170 to the wallet management system 106, where the offering selection data 170 indicates a merchant offering that the user of the mobile wallet application 104 is considering purchasing. Offering selection data 170 may be provided in any suitable manner. In some examples, the mobile wallet application 104 may make a content request 134 (FIG. 1) that identifies a merchant offering. The wallet management system 106 (e.g., secure caching module 118 thereof) may provide the mobile wallet application 104 with merchant web content 136, for example, as described herein above. The value token exchange module may determine the offering selection data 170, for example, from the web content requested by the mobile wallet application 104.

In some examples, the mobile wallet application may be in communication with a Point of Service (POS) device 166 to purchase an offering. The POS device 166 may be a device associated with a merchant that accepts a payment from the mobile wallet application 104. The POS device 166 may comprise a processing unit and various other computing components. In some examples, the POS device 166 may be or comprise a computing device configured, for example, according to one or more of the hardware or software architectures described herein. The POS device 166 may be configured to communicate with the mobile wallet application 104 using any suitable contact or a contactless medium. In some examples, the POS device 166 may be configured to communicate with the mobile wallet application 104 utilizing a short range communication medium such as, a Bluetooth connection, a Bluetooth LE connection, a Near Field Communications (NFC) connection, an infrared connection, etc.

In some examples, the POS device 166 may provide the mobile wallet application 104 with offering data, similar to offering selection data 170, describing an offering that is to be paid for. The mobile wallet application 104 may provide the data describing the offering to the value token exchange module 152. Also, in some examples, the POS device 166 may be in direct communication with the wallet management system 106 and may provide the offering data directly to the wallet management system 106 (e.g., the value token exchange module 152 thereof).

Also, in some examples, the mobile wallet application 104 (and/or a browser application executing at the user computing device 102) may receive merchant web content directly from the merchant web server 108. The mobile wallet application 104 may derive offering selection data 170 from the requested web content and provide the offering selection data 170 to wallet management system 106 (e.g., value token exchange 152).

The value token exchange module 152 may utilize the offering selection data 170 to determine value tokens 160A, 160B, 160C present or described at the value token pool 158 that could be redeemed in conjunction with the offering or offerings indicated by the offering selection data 170. The value token exchange module 152 may access and/or generate relevant value token data 172 describing the selected value tokens and provide the relevant value token data 172 to the mobile wallet application 104. In some embodiments, the relevant value token data 172 may also include indications of the mobile wallet application 164A, 164B, 164C that holds the selected value tokens 160A, 160B, 160C. The user of the mobile wallet application 104 may decide (or decide not) to acquire one or more of the value tokens 160A, 160B, 160C described by the relevant value token data 172. The mobile wallet application 104 may contact the mobile wallet application 164A, 164B, 164C that holds a value token that the mobile wallet application 104 would like to acquire. The two mobile wallet applications 104 and 164A, 164B, 164C may negotiate or otherwise agree on a price for the selected value token. For example, exchange negotiations 174 may include one or more communications between the mobile wallet application 104 and the mobile wallet application 164A, 164B, 164C that holds the selected value token. In some examples, the exchange negotiations 174 may include the mobile wallet application 104 sending offer data to the mobile wallet application 164A, 164B, 164C that holds the selected value token. The offer data may describe a price that the mobile wallet application 104 would pay to the mobile wallet application 164A, 164B, 164C that holds the selected value token (e.g., an offer price). The mobile wallet application 164A, 164B, 164C that holds the selected value token may reply with acceptance data indicating an acceptance of the offer, rejection data indicating a rejection of the offer, counter-offer data indicating a counter-offer, etc. If the original offer is not accepted, the mobile wallet application 104 may follow by accepting a counter offer, making a new offer, etc. In some examples, the user of the mobile wallet application 104 may decide to forgo the selected value token and/or to select and make a new offer on a different value token (e.g., held by a different mobile wallet application 164A, 164B, 164C).

In some examples, the mobile wallet application 104 may use a payment element to provide a payment for the selected value token to the mobile wallet application 164A, 164B, 164C that holds the selected value token. The mobile wallet application 164A, 164B, 164C holding the selected value token may provide the value token to the mobile wallet application 104, for example, by sending value token data for the value token, by sending a physical thing associated with the value token to a user of the mobile wallet application 104, etc. The mobile wallet application 104 may use the value token to purchase the relevant offering.

FIG. 4 is a flowchart showing one example of a process flow 400 that may be executed by the mobile wallet application 104 and a wallet management system 106 to acquire a value token and add the value token to the value token pool 158. The process flow 400 includes two columns. A first column 401 includes operations that may be executed by the mobile wallet application 104. A second column 403 includes operations that may be executed by the wallet management system 106 (e.g., the value token exchange module 152 thereof).

At operation 402, the mobile wallet application 104 may receive a value token. The value token may be received in any manner. For example, when the value token includes value token data (e.g., data that can be used to redeem the value token), receiving the value token may include receiving the value token data. The value token data may be received from any suitable source. For example, the value token data may be received from a merchant web server such as 108, from a social media web server, from another mobile wallet application 164A, 164B, 164C, etc.

In some examples, the value token may be or include a physical thing such as a card, a paper, etc., that is received by a user of the mobile wallet application 104. In some examples, the user may use the user computing device 102 to extract value token data and/or value token descriptive data from the physical thing. For example, the user computing device 102 may comprise a camera or similar sensor that may be used to scan and/or capture an image of the physical thing. The mobile wallet application 104 may extract value token data and/or value token descriptive data from the image. For example, the mobile wallet application 104 may be programmed to extract alphanumeric data from the image or scan. For example, the physical thing may include a bar code. The mobile wallet application 104 may extract numerical or other data identifying the value token from the bar code. Also, in some examples, the mobile wallet application 104 may be programmed to utilize an optical character recognition (OCR) or similar algorithm to read alphanumeric characters printed on the physical thing.

Value token data received by the mobile wallet application 104 and/or extracted from a physical thing may be formatted in any suitable form or syntax. For example, value token data may be formatted according to an extensible language, such as eXtensible Markup Language (XML) or a similar language. An example format for value token data is provided below according to the XML syntax:

```
<?xml version=″1.0″ encoding=″IS0-8859-1″ ?>
<Coupon>
  <MANIFEST>
    <Generator name>Value Coupon Inc</Generator>
    <DateIssued isfmt=″m/d/y″>04/05/2016</DateIssued>
    <DateExpires
expfmt=″m/d/y″>07/05/2016</DateExpires>
    <Issuer name=″Mycoffee Inc . ″> </Issuer>
    <DocumentType>MycoffeeCoupon.JPG</DocumentType>
  </MANIFEST>
  <Product>
    <Name>Coffee</Name>
    <Description
url=″http://www.mycoffee.com″></Description>
    <Value currency=″USD″>1.0</Value>
    <SerialNum>09780</SerialNum>
    <TermsURL=″
http://www.mycoffee.com/terms.html″><TermsURL>
  </Product>
</Coupon>
```

In the example above, the value token is a coupon for $1 off of a purchase at a fictional Internet merchant, MyCoffee, Inc. For example, the value token data includes a manifest section, <MANIFEST>, including a name of the generator of the value token, an issue date for the value token, an expiration date for the value token, an issuer or merchant who will redeem the value token, and a type of document indicating the value token. In the example above, the value token may be indicated by a JPEG or “.JPG” image file. For example, the value token data for the value token may include the XML code above in addition to a JPEG or other file including an image of the card or other physical thing of the value token. Of course, in examples where the value token lacks a physical thing, the reference to document type may be omitted. The value token data may also include a <Product> field indicating particulars of the value token including a URL of a merchant web server where the value token may be redeemed, a serial number of the value token, and a URL linking to a location of terms for the value token. Although the example above shows value token data, in some examples, value token descriptive data may be similarly formatted. Value token descriptive data, however, which is not redeemable, may omit the serial number and/or other data for redeeming the value token.

Referring back to FIG. 4, at operation 404, the mobile wallet application 104 may determine whether the value token is transferrable. The value token may be transferrable if it can be redeemed by a mobile wallet application other than the mobile wallet application 104. A mobile wallet may be non-transferrable, for example, it includes a term indicating that it can be redeemed only by the original recipient (e.g., user or associated mobile wallet application 104). If the value token is not transferrable, the mobile wallet application 104 may not add the value token to the value token pool 158. For example, the mobile wallet application 104 may write the value token data for the value token (and/or value token descriptive data for the value token) to a personal value token store, such as 152.

If the value token is transferrable, the mobile wallet application 104 may determine, at operation 406, whether the user would like to share the value token or save it. For example, the mobile wallet application 104 may prompt the user via the user interface 116. If the user chooses not to share the value token, then value token data may not be provided to the wallet management system 106 (for example, handled as described with respect to operation 404).

If the user chooses to share the value token data, the mobile wallet application 104 may, at operation 408, send value token descriptive data 405 for the value token to the wallet management system 106 (e.g., the value token exchange module 152 thereof). In some examples, the mobile wallet application 104 may send value token data itself in addition to or instead of the value token descriptive data. At operation 410, the mobile wallet application 104 may store the value token data and/or descriptive data for the value token, for example, to a shared value token data store 150.

The wallet management system 106 (e.g., the value token exchange module 152) may receive the value token descriptive data 405 at operation 412. At action 414, the wallet management system 106 (e.g., the value token exchange module 152) may add the value token described by the descriptive data 405 to the value token pool 158, for example, by writing the received value token descriptive data 405 to the value token data store 156.

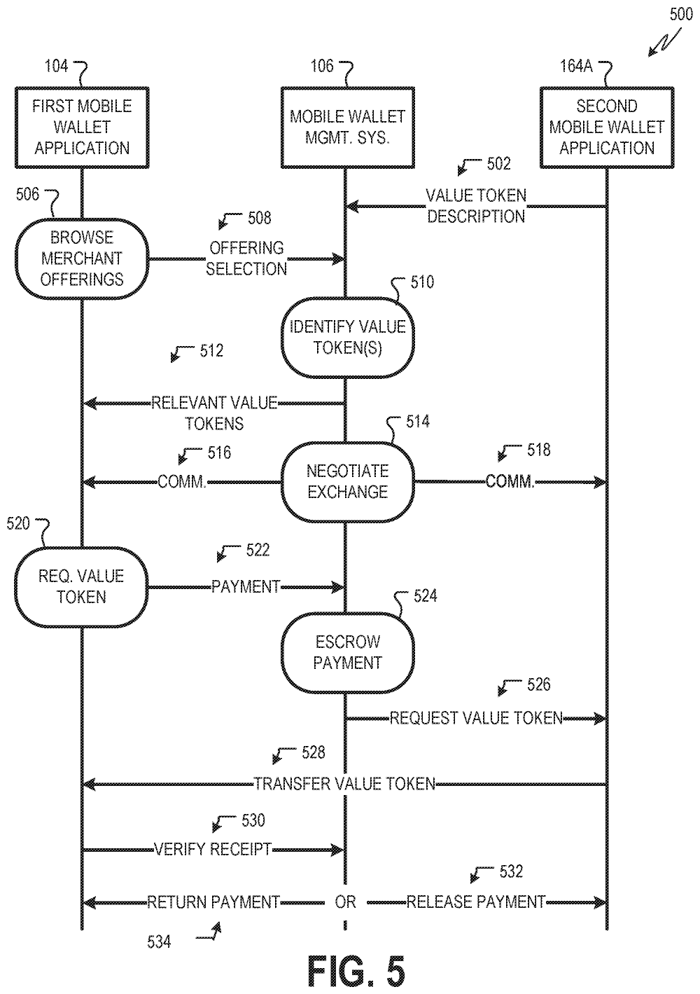

FIG. 5 is a transaction diagram 500 showing one example of transactions for exchanging a value token between a first mobile wallet application 104 and a second mobile wallet application 164A. The second mobile wallet 164A may provide a value token description 502 to the wallet management system 106 (e.g., the value token exchange module 152 thereof), for example, as described herein with respect to FIG. 4. The value token exchange module 152 may add the indicated value token to the value token pool 158 again, for example, as described herein with respect to FIG. 4.

At operation 506, the mobile wallet application 104 (and/or a user thereof) may browse merchant offerings. In some examples, the mobile wallet application 104 may receive merchant web content 136 that is or is derived from signed merchant web content 136 as described herein with respect to the secure caching module 118 (FIG. 1). In some examples, the mobile wallet application 104 may receive merchant web content directly from a merchant web server 108. In some examples, a user of the user computing device 102 may receive merchant web content from the merchant web server 108 or other source through a web browser application rather than or in addition to through the mobile wallet application 104. Also, in some examples, the user of the user computing device 102 may physically browse a bricks and mortar retail location of the merchant.

Upon selecting an offering, the mobile wallet application 104 may provide offering selection data 508 to the wallet management system 106. The offering selection data 508 may describe a merchant offering that the user of the wallet application 104 has decided to purchase or is considering purchasing. In some examples, the mobile wallet application 104 may send the offering selection data to the wallet management system 106. In some examples where the mobile wallet application receives merchant web content from the wallet management system 106, the wallet management system 106 may derive the offering selection data 508 from the web content provided to the mobile wallet application 104. Also, in some examples, the wallet management system 106 may receive the offering selection data 508 direction from a point of service device 166 or other device associated with the merchant.

At operation 510, the wallet management system 106 may identify value tokens described at the value token pool 158 that are relevant to the offering selection including, for example, value tokens that can be redeemed to reduce a price of the indicated offering. The wallet management system 106 may provide data 512 describing relevant data tokens to the first mobile wallet. The data 512 may describe value tokens that are relevant to the offering selection and may include, for example, data identifying the mobile wallet application or applications holding the value tokens described by the data 512. The first mobile wallet application 104 may select a value token held by a second mobile wallet application 164A.

At operation 514, the mobile wallet applications 104, 164A may negotiate a price for transferring the value token from the second mobile wallet application 164A to the mobile wallet application 104, for example, by exchanging offers, counter-offers and/or acceptances via communications 516, 518. In some examples, when the second mobile wallet application 164A provides the value token description 502 to the wallet management system 106, it may be accompanied by price data describing a price that the second mobile wallet application 164A will accept for the value token and/or other terms of an exchange for the value token. In this case, operations 514, 516, 518 may be omitted. Operations 516, 518, in some examples, may include secure wallet-to-wallet communications, which may be facilitated by the mobile wallet management system 106, as described herein.

At operation 520, the mobile wallet application 104 may request the value token and provide payment data 522 to the wallet management system 106. The wallet management system 106 may escrow the payment at operation 524. For example, the wallet management system 106 may debit an indicated payment element of the first mobile wallet application 104 but may not credit a payment element of the second mobile wallet 164A. The wallet management system 106 may send a value token request 526 to the second mobile wallet 164A. The request 526 may indicate that the wallet management system 106 is holding an escrow payment for the value token. In response, the second mobile wallet application 164A may transfer the value token at operation 528 to the first mobile wallet application 104. The operation 528 may occur in any suitable manner. For example, when the value token is digitally redeemable, the second mobile wallet 164A may send value token data for the value token to the first mobile wallet application 104. In examples where the value token is redeemable in-person, a user of the second mobile wallet application 164A may send a card or other physical thing associated with the value token to a user of the first mobile wallet application 104, for example, by post.

Upon receipt of the value token, the first mobile wallet application 104 may send a receive verification message 530 to the wallet management system 106 including verification data indicating that the first mobile wallet application 104 has received the value token. In response, the wallet management system may release the escrowed payment 532 to the appropriate payment element of the second mobile wallet application 164A. If the wallet management system 106 does not receive the verification message 530, instead of releasing the escrowed payment 532, the wallet management system 106 may return the payment 534 to the first mobile wallet application 104, for example, by sending return payment data to the mobile wallet application 104. (In some examples, escrowing may be provided by a third party service other than the wallet management system 106.) In some examples, the user of the first mobile wallet application 104 may select another value token from the relevant value tokens described by data 512 (e.g., held by a mobile wallet application other than 164A) and attempt to negotiate an exchange for the other value token as described.

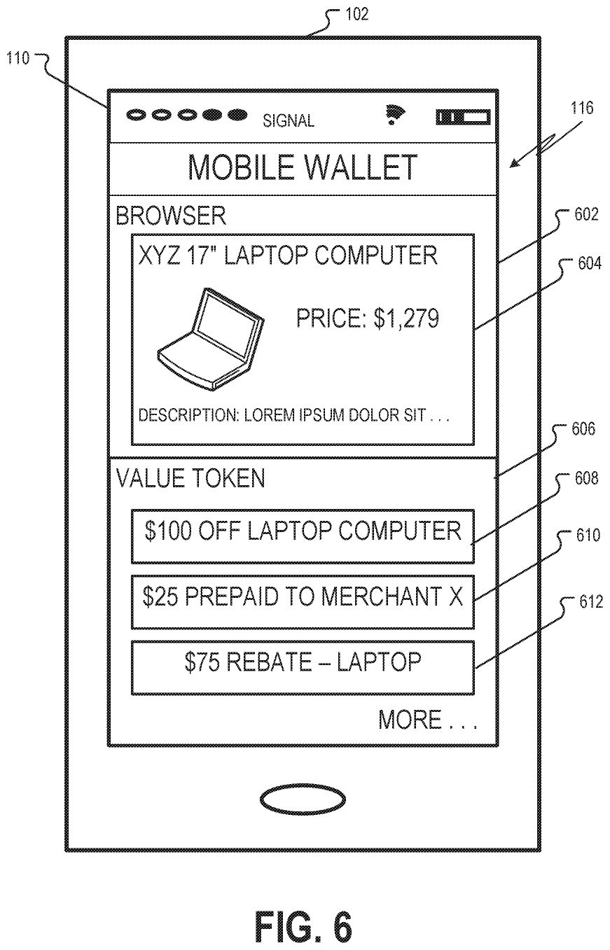

FIG. 6 is a diagram showing one example configuration of the user interface 116 provided to a user of the mobile wallet application 104 showing value tokens from the value token pool 153 that are relevant to a selected offering. The interface 116 is shown at a display 110 of the user computing device 102. For example, the display 110 may be a touch screen allowing a user to select items from the interface 116.

In the example of FIG. 6, the interface 116 comprises a web content field 602 and a value token field 606. The web content field 602 shows data describing a merchant offering. For example, the web content field 602 may utilize a WebView or other software construct enabling the mobile wallet application 104 to display web content. The web content displayed at the web content field 602 may include, for example, web content received and processed by the secure caching module 118. In the example shown in FIG. 6, the web content 604 displayed at the web content field 602 describes an offering of a laptop computer including, for example, a description of the laptop computer and a price for the laptop computer. A value token field 606 includes value token fields 608, 610, 612 describing value tokens from the value token pool 158 that could be applied to the offering, for example, because of the offered product (e.g., fields 608, 612) or because of the merchant making the offering (field 610).

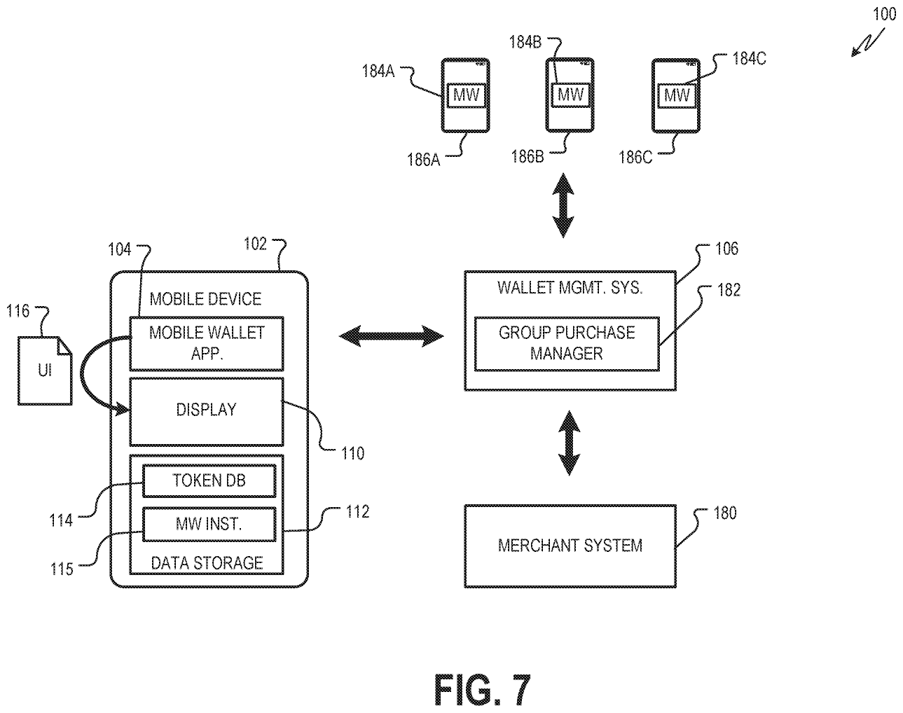

FIG. 7 is a diagram showing one example of the environment 100 configured to implement a group purchase incentive. For example, a mobile wallet provider may facilitate a group purchase event for mobile wallet users. The mobile wallet provider, a merchant, or other party may organize a group purchase incentive by offering or negotiating an incentive price or prices for an offering that are available when more than a threshold number of customers purchase the offering. In the example of FIG. 7, the wallet management system 106 comprises a group purchase manager 182 to facilitate a group purchase incentive. The group purchase manager 182 may be in communication with a merchant system 180 to determine a group purchase incentive. For example, a merchant associated with the merchant system 180 may accept a price for an offering that becomes lower as more mobile wallet users participate during an incentive period. In the example of FIG. 7, the environment 100 includes the mobile wallet application 104 as well as user computing devices 186A, 186B, 186C executing additional mobile wallet applications 184A, 184B, 184C.

When the group purchase incentive is determined, the group purchase manager 182 may communicate the group purchase incentive to the mobile wallet applications 184A, 184B, 184C, 104. Mobile wallet applications 184A, 184B, 184C may determine to accept, or not accept, the offering that is the subject of the group purchase incentive. For example, the mobile wallet application 104 may accept the relevant offering. The mobile wallet application 104 may provide a payment instruction to the wallet management system 106. The wallet management system 106 (e.g., the group purchase manager 182 thereof) may charge a first mobile wallet purchase price to a payment element of the mobile wallet application 104. The first mobile wallet purchase price may be a purchase price for the offering in view of the number of mobile wallet applications that have accepted the offering at the time that the mobile wallet application 104 accepted the offering. For example, as more mobile wallet applications accept the offering during the incentive period, the price may go down. In some examples, the group purchase manager 182 may escrow an escrow portion of the first mobile wallet purchase price until the end of the incentive period. The escrow portion may be the difference between the first mobile wallet purchase price and the lowest possible purchase price under the group purchase incentive. At the end of the incentive period, the group purchase manager 182 may determine the final purchase price for the offering (e.g., the purchase price at the end of the incentive period). If the final purchase price is less than the first mobile wallet purchase price, then a portion of the escrow amount equal to the difference between the first mobile wallet purchase price and the final purchase price may be returned to the first mobile wallet application 104. The remainder of the escrow portion, if any, may be sent to the merchant system 180.

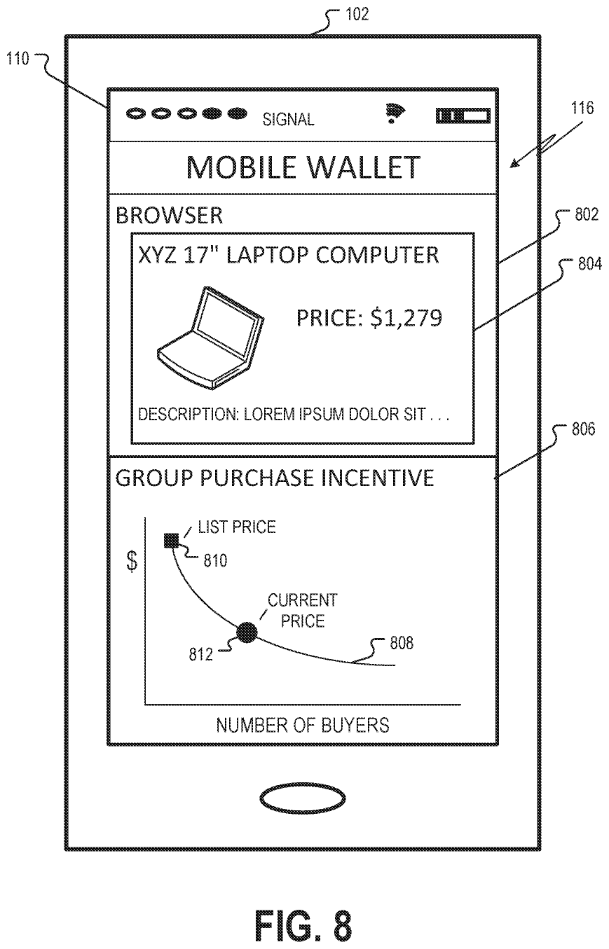

FIG. 8 is a diagram showing one example configuration of the user interface 116 provided to a user of the mobile wallet application 104 showing a group purchase incentive field 806. In the example of FIG. 8, the interface 116 comprises a web content field 802 and the group purchase incentive field 806. The web content field 802 shows data describing a merchant offering. For example, the web content field 802 may utilize a WebView or other software construct enabling the mobile wallet application 104 to display web content. The web content displayed at the web content field 802 may include, for example, web content received and processed by the secure caching module 118. In the example shown in FIG. 8, the web content 804 displayed at the web content field 802 describes an offering of a laptop computer including, for example, a description of the laptop computer and a price for the laptop computer.

The group purchase incentive field 806 shows a plot with a vertical axis indicating a price for the offering and a horizontal axis indicating the number of buyers. A curve 808 illustrates how the price of the offering is lowered as the number of buyers (e.g., other mobile wallet applications accepting the offering) goes up. A list price icon 810 indicating the list price of the offering without the group purchase incentive. A current price icon 812 indicates the current price of the offering. The right-most portion of the curve 808 (in the orientation shown in FIG. 8) may indicate the lowest possible price for the offering, with other prices on the curve, including the current price 812, being intermediate prices between the list price 810 and the lowest price. In some examples, different intermediate prices may have different associated thresholds (e.g., intermediate thresholds). In some examples, the mobile wallet application 104 may update the current price icon 812 as other customers purchase the offering.

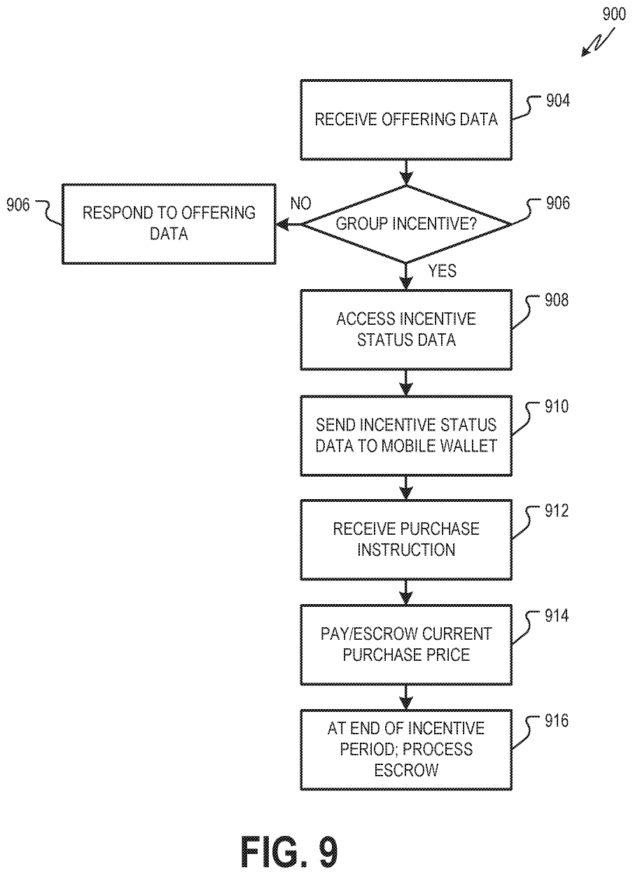

FIG. 9 is a flowchart showing one example of a process flow 900 that may be executed by the wallet management system 106 (e.g., the group purchase manager 182 thereof) to facilitate a group purchase incentive. At operation 904, the group purchase manager 182 may receive offering data indicating an offering of interest to a user of the mobile wallet application 104. The offering data may be of any suitable form including, for example, a content request 134 described in FIG. 1, data received from a web browser or other application executing at the user computing device 102, data received from a POS device 166 (FIG. 3), etc.

At operation 906, the group purchase manager 182 may determine if there is a group purchase incentive associated with the offering indicated by the offering data. If not, the group purchase manager 182 (and/or another component of the wallet management system 106) may respond to the received offering data, for example, by initiating a payment for a purchase, providing requested merchant web content, etc. If there is a group purchase incentive, the group purchase manager 182 may access incentive status data at operation 908. Incentive status data may indicate, for example, a number of purchasers under the group purchase incentive to date, a current price of the offering, one or more prices according to the incentive for different numbers of purchasers during the incentive period, an indication of the incentive period, etc. At operation 910, the group purchase manager 182 may send the incentive status data to the mobile wallet application 104. The mobile wallet application 104 may utilize the incentive status data to populate the user interface 116, for example, as shown in FIG. 8.

At operation 912, the group purchase manager 182 may receive a purchase instruction from the mobile wallet application 104 including purchase instruction data indicating that the mobile wallet application 104 (e.g., a use thereof) will accept the offering. At operation 914 the group purchase manager 182 may debit a payment element of the mobile wallet application 104 for the first mobile wallet purchase price, which may be equal to the current purchase price at the time that the purchase instruction was received. A portion of the first mobile wallet purchase price equal to the lowest price allowable under the group purchase incentive may be provided to the merchant as a merchant payment. The remainder of the first mobile wallet purchase price may be escrowed. At operation 916, at the end of the incentive period, the group purchase manager 182 may process the escrow. For example, if a final price for the offering at the conclusion of the incentive period is lower than the first mobile wallet price, then group purchase manager 182 may refund a difference between the first mobile wallet price and the final price, with the remainder being provided to the merchant. If the final price for the offering is equal to the first mobile wallet price, the group purchase manager may provide the entirety of the escrow payment to the merchant.

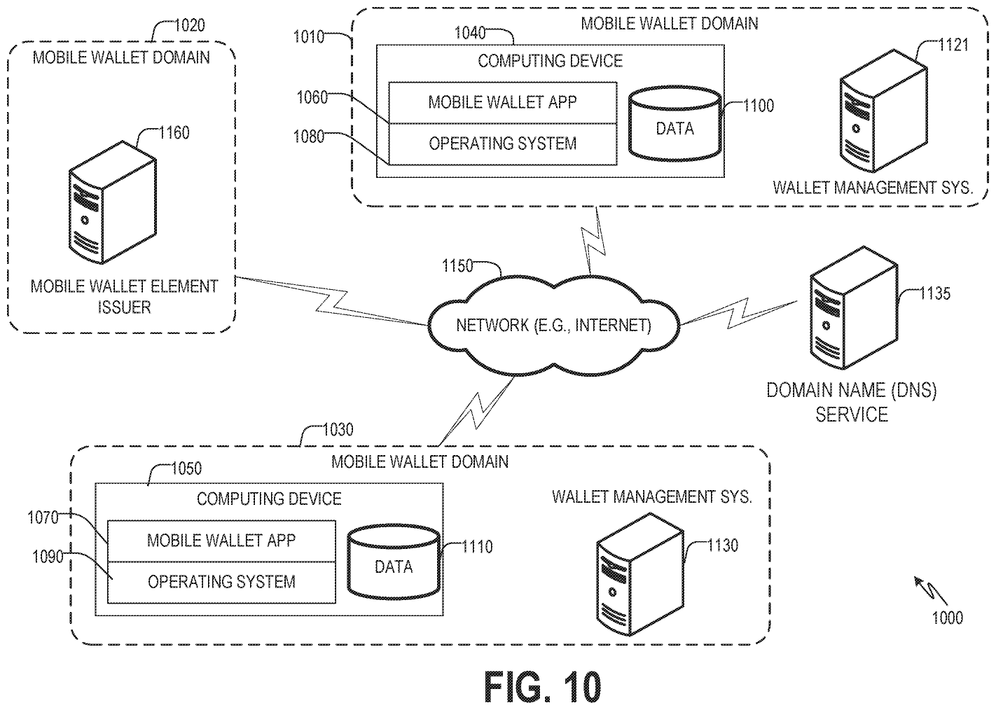

FIG. 10 is a diagram showing one example of an environment 1000 for secure digital communication between mobile wallet applications. For example, the components and techniques described with respect to FIG. 10 may be utilized in any of the methods and systems described herein. In the example environment 1000, three mobile wallet domains 1010, 1020, and 1030 are shown. Mobile wallet domains 1010 and 1030 include two respective user computing devices 1040 and 1050 with mobile wallet applications 1060 and 1070 executing along with operating systems 1080 and 1090 respectively. Mobile wallet domains may be provided by one or more mobile wallet providers (e.g., mobile wallet providers implementing the respective wallet management systems 1121, 1130. Mobile wallet providers may administer one or more mobile wallet domains. The mobile wallet applications 1060 and 1070 may originate from the wallet management systems 1121 and 1130 respectively. Wallet management systems 1121, 1130, in some examples, may operate similarly to the wallet management system 106 described herein. Similarly, mobile wallet applications 1060, 1070 may operate in a manner similar to the mobile wallet application 104 described herein.

Mobile wallet applications 1060 and 1070 store one or more data structures that store digital representations of payment and non-payment elements of the user. In some examples, this may be identification information (drivers licenses), financial information (credit card information, bank card information, bank account information), and the like. A digital representation may include one or more information fields stored by the mobile wallet and providing information about the user (e.g., account number, user age, user name, and the like) and in some cases verification (e.g., a certificate or other means to assure that the digital representation is authentic). Operating systems 1080 and 1090 provide services to the mobile wallets (and other applications) on the computing devices 1040 and 1050 such as scheduling tasks for execution, controlling peripherals, providing an interface to the hardware, managing memory, and the like.

Computing devices 1040 and 1050 may also contain data storage devices 1100 and 1110 that may store mobile wallet application data, including mobile wallet messages, encryption keys, address books, data structures storing information about the user of the computing device (such as information on payment and non-payment elements of the mobile wallet), and the like. Mobile wallet domains 1010, and 1030 may have wallet management systems 1121 and 1130 that provide mobile wallet communication services to the mobile wallets within their respective mobile wallet domains 1010 and 1030. Example services include message forwarding, message storage, message encryption, and the like.

Domain Name Service (DNS) 1135 translates a domain name (e.g., abc.mwallet) to an Internet Protocol (IP) address that may be utilized to send messages to that mobile wallet domain. Mobile wallet domains 1010, 1020, 1030, and DNS 1135 may communicate over computer network 1150, which in some examples may be or include the Internet. Mobile wallet domain 1020 may include mobile wallet element issuer 1160. Mobile wallet element issuer 1160 may contain applications which may communicate with mobile wallets in other mobile wallet domains according to the present disclosure. Example mobile wallet issuers include banks, merchants, government organizations, corporations, or the like.

Mobile wallet element issuer 1160 may issue one or more identification cards, credit cards, bank cards, bank accounts, or the like to one or more users of mobile wallets (e.g., mobile wallet applications 1060 and 1070). Mobile wallet element issuer 1160 may include one or more of the components of wallet management systems 1121 and 1130 as shown in FIG. 2 (e.g., PKS, MTA, MSA). In some examples, these elements may be issued by sending the digital representations to one or more mobile wallet recipients. Thus, using the disclosed techniques, it may be possible to automatically provision and populate a mobile wallet with little consumer effort.

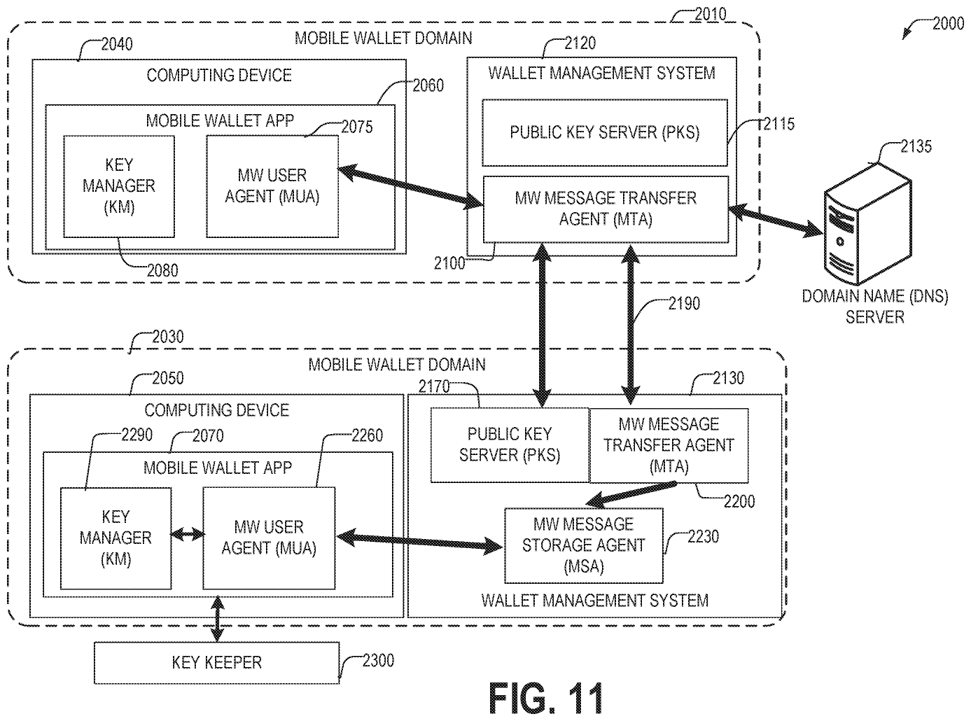

FIG. 11 is a diagram showing one example of a mobile wallet to mobile wallet secure digital communication 2000. Mobile wallet domain 2010 may be an example implementation of mobile wallet domain 1010 and mobile wallet domain 2030 may be an example implementation of mobile wallet domain 1030 of FIG. 10. Similarly, computing device 2040, mobile wallet application 2060 and wallet management system 2120 may be an example implementation of computing device 1040, mobile wallet application 1060 and wallet management system 1121 respectively of FIG. 1 in some examples. Computing device 2050, mobile wallet application 2070 and wallet management system 2130 may be an example implementation of computing device 1050, mobile wallet application 1070 and wallet management system 1130 respectively of FIG. 1 according to some examples.

A first mobile wallet application 2060 executing on a computing device 2040 in a first mobile wallet domain 2010 is sending a message to a second mobile wallet application 2070 executing on a second computing device 2050 in a second mobile wallet domain 2030. Mobile wallet application 2060 may include a mobile wallet user agent (MUA) 2070 and a key manager 2080. The MUA 2075 allows users to compose, send and retrieve mobile wallet (MW) messages. Key manager 2080 may one or more of: create, provision, register, store, and manage one or more cryptographic keys. Key manager 2080 may register (or obtain) a public key with a certificate authority (not shown for clarity) and with a PKS 2115.

A mobile wallet application 2060 may provide one or more graphical user interfaces (GUI)s to allow users to compose and edit one or more mobile wallet messages. Before sending a message, the MUA 2075 requests the recipient's public key from the MTA 2100. The PKS 2115 and MTA 2100 may be provided by the wallet management system 2120 of the mobile wallet domain 2010. The PKS 2115 and MTA 2100 may be provided by the same computing device, or different computing devices. While the PKS 2115 and MTA 2100 are shown as part of the wallet management system 2120, they may be provided by separate entities. The MTA and PKS are accessible to computing device 2040 and other computing devices both within the mobile wallet domain 2010 and other devices within other mobile wallet domains, over one or more networks (not shown for clarity). These networks may include one or more portions of: Local Area Networks (LAN), Wide Area Networks (WAN), Metropolitan Area Networks (MAN), the Internet, cellular networks, and the like.

The MTA 2100 first examines the message to determine which mobile wallet domain the recipient is in. If the mobile wallet domain is mobile wallet domain 2010, the MTA may retrieve the public key from the PKS 2115 of mobile wallet domain 2010. If the mobile wallet domain is in another domain, then the MTA checks its DNS cache to determine if it already knows the IP address of the recipient mobile wallet domain's PKS. If the mobile wallet domain is not in the DNS cache, the MW sends a lookup message to DNS server 2135 using the Domain Name System Protocol. DNS server 2135 responds with an IP address of the mobile wallet domain (or an error). Once the address is determined (either through the cache or the DNS server 2135), the MTA 2100 sends a message to the PKS 2170 asking for the public key of the recipient mobile wallet (e.g., mobile wallet application 2070). The response includes the recipient's public key. The public key is then passed by the MTA 2100 to the MUA 2075.

In some examples, the public key is passed to the MTA 2100 in the form of a digital certificate issued by a Certificate Authority (CA). A digital certificate typically includes the name and other identification information of the holder, the holder's public key, the name of the CA, a serial number, and a validity period. The information in the digital certificate is signed by the issuing CA using the issuing CA's private key. The signature can be verified using the CA's public key (which is known and may be pre-installed on the computing devices). This may serve as a means to verify that the public key is owned by the recipient. For example, the PKS 2170 may provide a digital certificate created by a trusted CA for the recipient mobile wallet application 2070 in response to the request for the recipient's public key. MUA 2075 (or MTA 2100) may utilize the CA's public key and decrypt the certificate. The certificate may then be checked to determine that the message was not tampered with, and that the public key therein belongs to the mobile wallet application 2070 (e.g., authentication and verification).

Once the MUA 2075 is satisfied with the public key, the MUA 2075 then encrypts the contents of the message with the received public key and sends it to the MTA 2100. The MTA 2100 determines the IP Address of the recipient mobile wallet domain's MTA 2200. In some examples, the MTA 2100 utilizes the IP Address previously determined from the DNS server (e.g., using the cache) when retrieving the public key of the recipient. For example, the PKS 2170 and MTA 2200 may have the same IP Address, or the IP Address of the MTA 2200 may be derivable from the IP Address of the PKS 2170. In other examples a mobile wallet application in mobile wallet domain 2010 may have previously communicated with a mobile wallet in mobile wallet domain 2030 (and thus the MTA 2100 still has the IP Address in its cache). In other examples, the MTA 2100 may re-request the IP Address from the DNS server 2135.

The MTA 2100 then sends the message 2190 to the MTA 2200 of the wallet management system 2130 of the recipient mobile wallet domain 2030 using the determined IP address. MTA 2200 may send a response to MTA 2100 (which may be forwarded to MUA—but this message is not shown for clarity). MTA 2200 may then send the message to the mobile wallet message storage agent (MSA) 2230. Note that the wallet management system 2120 may also employ a MSA, but it is not shown for clarity. MSA 2230 may then store the message and alert the MUA 2260 of the recipient mobile wallet application 2070 using a notification. When the MUA is interested in receiving the message, the MUA may request it and the MSA may provide it. The MUA may decrypt the message using its private key. The private key may be maintained in the key manager 2290. Key manager 2290 may communicate with key keeper 2300. Key keeper 2300 may be a remote key storage facility to prevent the loss of the cryptographic keys should the computing device 2050 experience a loss in data. For example, the key manager 2290 may store one or more keys of the mobile wallet application 2070 in the key keeper 2300.

In some examples, the mobile wallet application 2070 may utilize a second cryptographic key to encrypt the private key. The private key may then be stored with the wallet management system 2130 in encrypted form. The second cryptographic key may then be stored with the key keeper 2300 and utilized to decrypt the private key should the computing device 2050 need it. The key keeper 2300 may be under control of the user of computing device 2050. This ensures that the private key is not given to the wallet management system 2130 and thus the user can entrust that no one associated with the wallet management system 2130 can access their messages.

FIG. 12 is a block diagram showing an example architecture 1220 of a user computing device. For example, the architecture 1200, for example, may describe any of the computing devices described. The architecture 1200 comprises a processor unit 1210. The processor unit 1210 may include one or more processors. Any of a variety of different types of commercially available processors suitable for user computing devices may be used (for example, an XScale architecture microprocessor, a Microprocessor without Interlocked Pipeline Stages (MIPS) architecture processor, or another type of processor). A memory 1220, such as a Random Access Memory (RAM), a Flash memory, or other type of memory or data storage, is typically accessible to the processor. The memory 1220 may be adapted to store an operating system (OS) 1230, as well as application programs 1240. In some examples, the OS may implement software interrupts that cause the architecture 1120 to pause its current task and execute an interrupt service routine (ISR) when an interrupt is received.

The processor unit 1210 may be coupled, either directly or via appropriate intermediary hardware, to a display 1250 and to one or more input/output (I/O) devices 1260, such as a keypad, a touch panel sensor, a microphone, and the like. Such I/O devices 1260 may include a touch sensor for capturing fingerprint data, a camera for capturing one or more images of the user, a retinal scanner, or any other suitable devices. Similarly, in some examples, the processor unit 1210 may be coupled to a transceiver 1270 that interfaces with an antenna 1290. The transceiver 1270 may be configured to both transmit and receive cellular network signals, wireless data signals, or other types of signals via the antenna 1290, depending on the nature of the user computing device implemented by the architecture 1120. Although one transceiver 1270 is shown, in some examples, the architecture 1120 includes additional transceivers. For example, a wireless transceiver may be utilized to communicate according to an IEEE 802.11 specification, such as Wi-Fi and/or to a short range communication medium. Some short range communication mediums, such as NFC, may utilize a separate, dedicated transceiver. Further, in some configurations, a GPS receiver 1280 may also make use of the antenna 1290 to receive GPS signals. In addition to or instead of the GPS receiver 1280, any suitable location-determining sensor may be included and/or used including, for example, a Wi-Fi positioning system. In some examples, the architecture (e.g., processor unit 1210) may also support a hardware interrupt. In response to a hardware interrupt, the processor unit 1210 may pause its processing and execute an interrupt service routine (ISR).

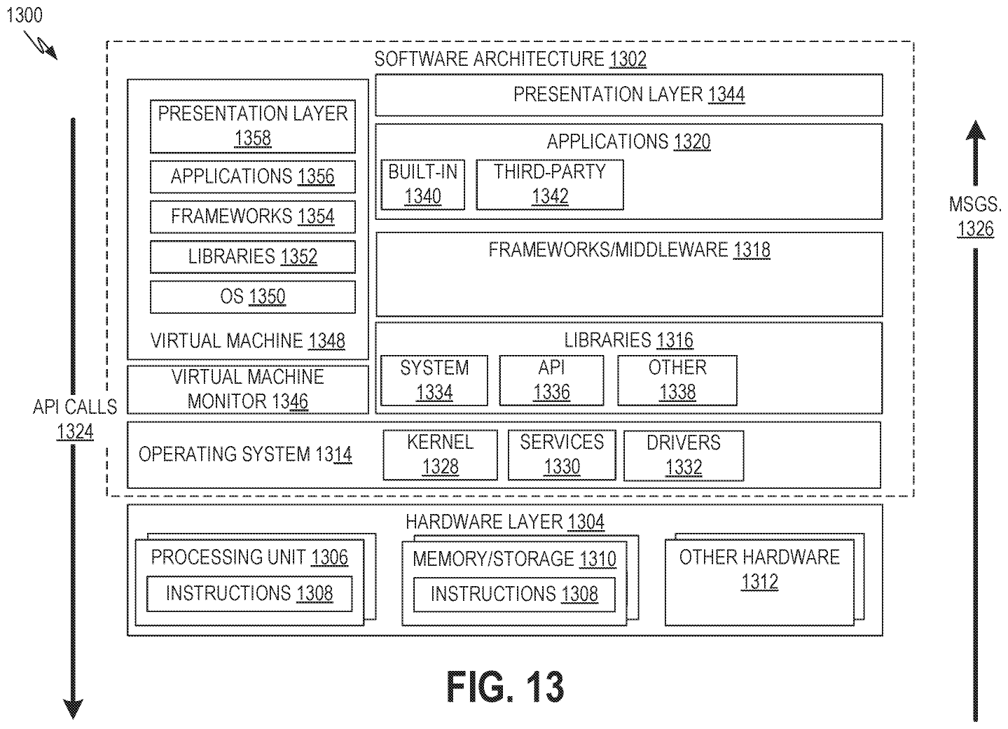

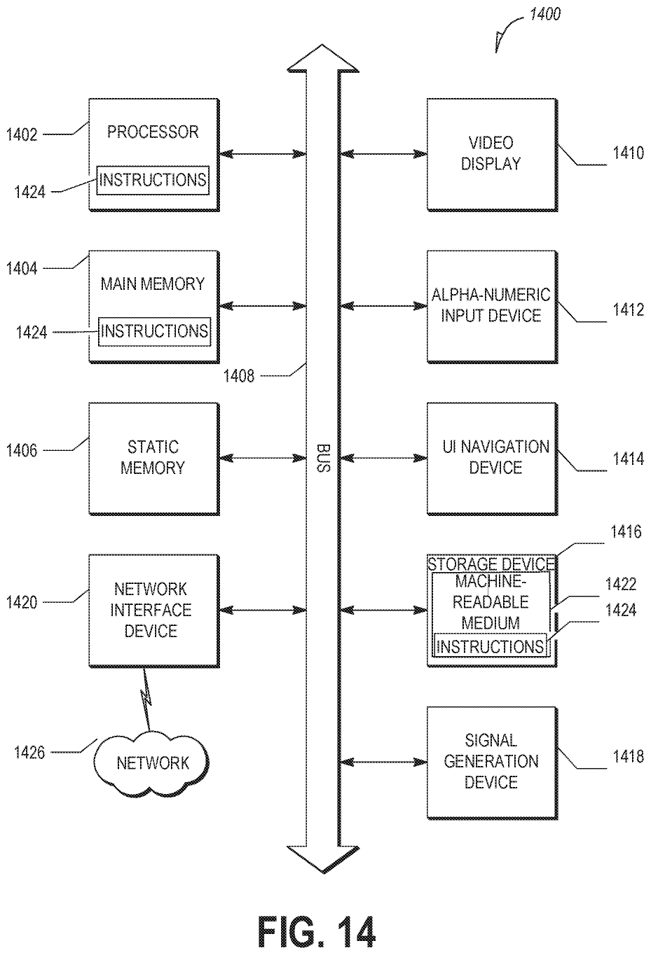

FIG. 13 is a block diagram 1300 showing one example of a software architecture 1302 for a computing device. The architecture 1302 maybe used in conjunction with various hardware architectures, for example, as described herein. FIG. 13 is merely a non-limiting example of a software architecture 1302 and many other architectures may be implemented to facilitate the functionality described herein. A representative hardware layer 1304 is illustrated and can represent, for example, any of the above referenced computing devices. In some examples, the hardware layer 1304 may be implemented according to the architecture 1302 of FIG. 13 and/or the architecture 1400 of FIG. 14.

The representative hardware layer 1304 comprises one or more processing units 1306 having associated executable instructions 1308. Executable instructions 1308 represent the executable instructions of the software architecture 1302, including implementation of the methods, modules, components, and so forth of FIGS. 1-8. Hardware layer 1304 also includes memory and/or storage modules 1310, which also have executable instructions 1308. Hardware layer 1304 may also comprise other hardware as indicated by other hardware 1312 which represents any other hardware of the hardware layer 1304, such as the other hardware illustrated as part of hardware architecture 1400.

In the example architecture of FIG. 13, the software 1302 may be conceptualized as a stack of layers where each layer provides particular functionality. For example, the software 1302 may include layers such as an operating system 1314, libraries 1316, frameworks/middleware 1318, applications 1320 and presentation layer 1344. Operationally, the applications 1320 and/or other components within the layers may invoke application programming interface (API) calls 1324 through the software stack and receive a response, returned values, and so forth illustrated as messages 1326 in response to the API calls 1324. The layers illustrated are representative in nature and not all software architectures have all layers. For example, some mobile or special purpose operating systems may not provide a frameworks/middleware layer 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. In some examples, the services 1330 include an interrupt service. The interrupt service may detect the receipt of a hardware or software interrupt and, in response, cause the architecture 1302 to pause its current processing and execute an interrupt service routine (ISR) when an interrupt is received. The ISR may generate the alert, for example, as described herein.

The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1316 may provide a common infrastructure that may be utilized by the applications 1320 and/or other components and/or layers. The libraries 1316 typically provide functionality that allows other software modules to perform tasks in an easier fashion than to interface directly with the underlying operating system 1314 functionality (e.g., kernel 1328, services 1330 and/or drivers 1332). The libraries 1316 may include system 1334 libraries (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The frameworks 1318 (also sometimes referred to as middleware) may provide a higher-level common infrastructure that may be utilized by the applications 1320 and/or other software components/modules. For example, the frameworks 1318 may provide various graphic user interface (GUI) functions, high-level resource management, high-level location services, and so forth. The frameworks 1318 may provide a broad spectrum of other APIs that may be utilized by the applications 1320 and/or other software components/modules, some of which may be specific to a particular operating system or platform.

The applications 1320 includes built-in applications 1340 and/or third party applications 1342. Examples of representative built-in applications 1340 may include, but are not limited to, a contacts application, a browser application, a book reader application, a location application, a media application, a messaging application, and/or a game application. Third party applications 1342 may include any of the built in applications as well as a broad assortment of other applications. In a specific example, the third party application 1342 (e.g., an application developed using the Android™ or iOS™ software development kit (SDK) by an entity other than the vendor of the particular platform) may be mobile software running on a mobile operating system such as iOS™, Android™, Windows® Phone, or other user computing device operating systems. In this example, the third party application 1342 may invoke the API calls 1324 provided by the mobile operating system such as operating system 1314 to facilitate functionality described herein.

The applications 1320 may utilize built in operating system functions (e.g., kernel 1328, services 1330 and/or drivers 1332), libraries (e.g., system 1334, APIs 1336, and other libraries 1338), frameworks/middleware 1318 to create user interfaces to interact with users of the system. Alternatively, or additionally, in some systems interactions with a user may occur through a presentation layer, such as presentation layer 1344. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 13, this is illustrated by virtual machine 1348. A virtual machine creates a software environment where applications/modules can execute as if they were executing on a hardware computing device. A virtual machine is hosted by a host operating system (operating system 1314) and typically, although not always, has a virtual machine monitor 1346, which manages the operation of the virtual machine as well as the interface with the host operating system (i.e., operating system 1314). A software architecture executes within the virtual machine such as an operating system 1350, libraries 1352, frameworks/middleware 1354, applications 1356 and/or presentation layer 1358. These layers of software architecture executing within the virtual machine 1348 can be the same as corresponding layers previously described or may be different.

FIG. 14 is a block diagram illustrating a computing device hardware architecture 1400, within which a set or sequence of instructions can be executed to cause the machine to perform examples of any one of the methodologies discussed herein. For example, the architecture 1400 may execute the software architecture 1302 described with respect to FIG. 13. The architecture 1400 may operate as a standalone device or may be connected (e.g., networked) to other machines. In a networked deployment, the architecture 1400 may operate in the capacity of either a server or a client machine in server-client network environments, or it may act as a peer machine in peer-to-peer (or distributed) network environments. The architecture 1400 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1400 includes a processor unit 1402 comprising at least one processor (e.g., a central processing unit (CPU), a graphics processing unit (GPU) or both, processor cores, compute nodes, etc.). The architecture 1400 may further comprise a main memory 1404 and a static memory 1406, which communicate with each other via a link 1408 (e.g., bus). The architecture 1400 can further include a video display unit 1410, an alphanumeric input device 1412 (e.g., a keyboard), and a user interface (UI) navigation device 1414 (e.g., a mouse). In some examples, the video display unit 1410, input device 1412 and UI navigation device 1414 are incorporated into a touch screen display. The architecture 1400 may additionally include a storage device 1416 (e.g., a drive unit), a signal generation device 1418 (e.g., a speaker), a network interface device 1420, and one or more sensors (not shown), such as a global positioning system (GPS) sensor, compass, accelerometer, or other sensor.

In some examples, the processor unit 1402 or other suitable hardware component may support a hardware interrupt. In response to a hardware interrupt, the processor unit 1402 may pause its processing and execute an interrupt service routine (ISR), for example, as described herein.

The storage device 1416 includes a machine-readable medium 1422 on which is stored one or more sets of data structures and instructions 1424 (e.g., software) embodying or utilized by any one or more of the methodologies or functions described herein. The instructions 1424 can also reside, completely or at least partially, within the main memory 1404, static memory 1406, and/or within the processor 1402 during execution thereof by the architecture 1400, with the main memory 1404, static memory 1406, and the processor 1402 also constituting machine-readable media. Instructions stored at the machine-readable medium 1422 may include, for example, instructions for implementing the software architecture 1302, instructions for executing any of the features described herein, etc.

While the machine-readable medium 1422 is illustrated in an example to be a single medium, the term “machine-readable medium” can include a single medium or multiple media (e.g., a centralized or distributed database, and/or associated caches and servers) that store the one or more instructions 1424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1424 can further be transmitted or received over a communications network 1426 using a transmission medium via the network interface device 1420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method, comprising:
requesting merchant web content, by a wallet management system and from a merchant web server, the wallet management system configured to manage a mobile wallet domain comprising a plurality of mobile wallet applications;
executing, by a processor unit of a user computing device, a first mobile wallet application of the plurality of mobile wallet applications, the first mobile wallet application to manage a first payment element associated with a first user account for funding payments;
receiving, by the first mobile wallet application and from the wallet management system, listing data, the listing data describing merchant web content that has been received by the wallet management system from the merchant web server and verified by the wallet management system, the merchant web content also being available to the user computing device directly from the merchant web server;
sending, by the first mobile wallet application, a content request to the wallet management system, the content request describing first merchant web content described by the listing data;
receiving, by the first mobile wallet application and from the wallet management system, the first merchant web content describing a first offering, the first merchant web content received from the wallet management system comprising first address data describing a first address of a first merchant payment gateway; and
sending payment data, by the first mobile wallet application and to the first merchant payment gateway at the first address, the payment data to initiate a payment for the first offering, the payment data indicating a payment amount for the payment and element data describing the first payment element.

2. The method of claim 1; further comprising:
receiving, by the first mobile wallet application and from the wallet management system, first offering value token descriptive data describing a plurality of value tokens redeemable to reduce a price of the first offering, wherein the first offering value token descriptive data describes a first value token held by a second mobile wallet application;
sending, to the second mobile wallet application, offer data describing an offer for the first value token, wherein the offer data describes an offer price to be paid by the first mobile wallet application to the second mobile wallet application for the first value token;
receiving, from the second mobile wallet application, acceptance data indicating that the offer price for the first value token is accepted;
sending, to the wallet management system, payment data authorizing payment of the offer price to the second mobile wallet application;
receiving the first value token from the second mobile wallet application; and
sending, to the wallet management system, verification data indicating that the first mobile wallet application has received the first value token.

3. The method of claim 2, wherein receiving the first value token from the second mobile wallet application comprises receiving redeemable value token data for the first value token.

4. The method of claim 2, further comprising:
providing a user interface at least in part at a display of the user computing device, wherein the user interface comprises:
a web content field comprising data describing the first offering; and
a value token field describing at least a portion of the plurality of value tokens redeemable to reduce the price of the first offering.

5. The method of claim 2, wherein the sending of the offer data to the second mobile wallet application comprises:
sending, by the first mobile wallet application, a request to the wallet management system for a public key associated with the second mobile wallet application;
receiving, by the first mobile wallet application, the public key;
encrypting, by the first mobile wallet application, the offer data with the public key to generate encrypted offer data; and
sending, by the first mobile wallet application, the encrypted offer data to the wallet management system.

6. The method of claim 2, further comprising:
receiving, by the first mobile wallet application, a second value token;
determining, by the first mobile wallet application, that the second value token is transferrable; and
sending, by the first mobile wallet application, second value token descriptive data describing the second value token to the wallet management system.

7. The method of claim 1, wherein the first mobile wallet application comprises a webview, and wherein the webview is configured to format the first merchant web content describing the first offering for display at the user computing device.

8. The method of claim 1, further comprising:
receiving, by the first mobile wallet application and from the wallet management system, first offering value token descriptive data describing a plurality of value tokens redeemable to reduce a price of the first offering, wherein the first offering value token descriptive data describes a first value token held by a second mobile wallet application;
sending, to the second mobile wallet application, offer data describing an offer for the first value token, wherein the offer data describes an offer price to be paid by the first mobile wallet application to the second mobile wallet application for the first value token;
receiving, from the second mobile wallet application, acceptance data indicating that the offer price for the first value token is accepted;
sending, to the wallet management system, payment data authorizing that payment of the offer price to the second mobile wallet application; and
upon failing to receive the first value token from the second mobile wallet application, receiving, from the wallet management system, return payment data indicating that the offer price will not be paid to the second mobile wallet application.

9. A system, comprising:
a wallet management system configured to manage a mobile wallet domain comprising a plurality of mobile wallet applications, the wallet management system being pro rammed to request merchant web content from a merchant web server; and
a user computing device comprising a processor unit and a memory in communication with the processor unit, the user computing device being programmed to execute operations comprising:
executing a first mobile wallet application of the plurality of mobile wallet applications, the first mobile wallet application to manage a first payment element associated with a first user account for funding payments;
receiving listing data, by the first mobile wallet application and from the wallet management system, the listing data describing merchant web content that has been received by the wallet management system from the merchant web server and verified by the wallet management system, the merchant web content also being available to the user computing device directly from the merchant web server;
sending, by the first mobile wallet application, a content request to the wallet management system, the content request describing first merchant web content, the first merchant web content described by the listing data;
receiving, by the first mobile wallet application and from the wallet management system, the first merchant web content describing a first offering, the first merchant web content received from the wallet management system comprising first address data describing a first address of a first merchant payment gateway; and
sending payment data, by the first mobile wallet application and to the first merchant payment gateway at the first address, the payment data to initiate a payment for the first offering, the payment data indicating a payment amount for the payment and element data describing the first payment element.

10. The system of claim 9, wherein the user computing device is further programmed to execute operations comprising:
receiving, by the first mobile wallet application and from the wallet management system, first offering value token descriptive data describing a plurality of value tokens redeemable to reduce a price of the first offering, wherein the first offering value token descriptive data describes a first value token held by a second mobile wallet application;
sending, to the second mobile wallet application, offer data describing an offer for the first value token, wherein the offer data describes an offer price to be paid by the first mobile wallet application to the second mobile wallet application for the first value token;
receiving, from the second mobile wallet application, acceptance data indicating that the offer price for the first value token is accepted;
sending, to the wallet management system, payment data authorizing payment of the offer price to the second mobile wallet application;
receiving the first value token from the second mobile wallet application; and
sending, to the wallet management system, verification data indicating that the first mobile wallet application has received the first value token.

11. The system of claim 10, wherein receiving the first value token from the second mobile wallet application comprises receiving redeemable value token data for the first value token.

12. The system of claim 10, wherein the user computing device is further programmed to execute operations comprising:
providing a user interface at least in part at a display of the user computing device, wherein the user interface comprises:
a web content field comprising data describing the first offering; and
a value token field describing at least a portion of the plurality of value tokens redeemable to reduce the price of the first offering.

13. The system of claim 10, wherein the sending of the offer data to the second mobile wallet application comprises:
sending, by the first mobile wallet application, a request to the wallet management system for a public key associated with the second mobile wallet application;
receiving, by the first mobile wallet application; the public key;
encrypting, by the first mobile wallet application, the offer data with the public key to generate encrypted offer data; and
sending, by the first mobile wallet application, the encrypted offer data to the wallet management system.

14. The system of claim 10, wherein the user computing device is further programmed to execute operations comprising:
receiving, by the first mobile wallet application, a second value token;
determining, by the first mobile wallet application, that the second value token is transferrable; and
sending, by the first mobile wallet application, second value token descriptive data describing the second value token to the wallet management system.

15. The system of claim 9, wherein the first mobile wallet application comprises a webview, and wherein the webview is configured to format the first merchant web content describing the first offering for display at the user computing device.

16. The system of claim 9, wherein the user computing device is further programmed to execute operations comprising:
receiving, by the first mobile wallet application and from the wallet management system, first offering value token descriptive data describing a plurality of value tokens redeemable to reduce a price of the first offering, wherein the first offering value token descriptive data describes a first value token held by a second mobile wallet application;
sending, to the second mobile wallet application, offer data describing an offer for the first value token, wherein the offer data describes an offer price to be paid by the first mobile wallet application to the second mobile wallet application for the first value token;
receiving, from the second mobile wallet application, acceptance data indicating that the offer price for the first value token is accepted;
sending, to the wallet management system, payment data authorizing that payment of the offer price to the second mobile wallet application; and
upon failing to receive the first value token from the second mobile wallet application, receiving, from the wallet management system, return payment data indicating that the offer price will not be paid to the second mobile wallet application.

17.-20. (canceled)

21. A tangible machine-readable medium comprising instructions thereon that, when executed by a processor unit, cause the processor unit to perform operations comprising:
requesting merchant web content, by a wallet management system and from a merchant web server, the wallet management system configured to manage a mobile wallet domain comprising a plurality of mobile wallet applications;
executing a first mobile wallet application, the first mobile wallet application of the plurality of mobile wallet applications to manage a first payment element associated with a first user account for funding payments;
receiving listing data, by the first mobile wallet application and from the wallet management system, the listing data describing merchant web content that has been received by the wallet management system from the merchant web server and verified by the wallet management system, the merchant web content also being available to the processor unit directly from the merchant web server;
sending, by the first mobile wallet application, a content request to the wallet management system, the content request describing first merchant web content, the first merchant web content described by the listing data;
receiving, by the first mobile wallet application and from the wallet management system, the first merchant web content describing a first offering, the first merchant web content received from the wallet management system comprising first address data describing a first address of a first merchant payment gateway; and
sending payment data, by the first mobile wallet application and to the first merchant payment gateway at the first address, the payment data to initiate a payment for the first offering, the payment data indicating a payment amount for the payment and element data describing the first payment element.

22. The medium of claim 21, the operations further comprising:
receiving, by the first mobile wallet application and from the wallet management system, first offering value token descriptive data describing a plurality of value tokens redeemable to reduce a price of the first offering, wherein the first offering value token descriptive data describes a first value token held by a second mobile wallet application;
sending, to the second mobile wallet application, offer data describing an offer for the first value token, wherein the offer data describes an offer price to be paid by the first mobile wallet application to the second mobile wallet application for the first value token;
receiving, from the second mobile wallet application, acceptance data indicating that the offer price for the first value token is accepted;
sending, to the wallet management system, payment data authorizing payment of the offer price to the second mobile wallet application;
receiving the first value token from the second mobile wallet application; and
sending, to the wallet management system, verification data indicating that the first mobile wallet application has received the first value token.

23. The medium of claim 22, wherein receiving the first value token from the second mobile wallet application comprises receiving redeemable value token data for the first value token.

24. The medium of claim 22, further comprising:
providing a user interface at least in part at a display, wherein the user interface comprises:
a web content field comprising data describing the first offering; and
a value token field describing at least a portion of the plurality of value tokens redeemable to reduce the price of the first offering.
